(19) United States
(12) Patent Application Publication
(10) Pub. No.: US 2005/0164013 A1
(43) Pub. Date: Jul. 28, 2005

(54) Thin sheet mirror and Nd2O3 doped glass

(76) Inventor: Ronald Leroy Stewart, Big Flats, NY (US)

Correspondence Address: CORNING INCORPORATED, SP-TI-3-1, CORNING, NY, 14831, US

(21) Appl. No.: 11/042,301

(22) Filed: Jan. 24, 2005

Related U.S. Application Data
(63) Continuation-in-part of application No. 10/016,840, filed on Dec. 13, 2001, now Pat. No. 6,881,489.
(60) Provisional application No. 60/255,759, filed on Dec. 15, 2000.

(51) Int. Cl. B32B 17/06

(52) U.S. Cl. 428/432; 428/434

(57) ABSTRACT

A reflecting mirror comprising a sheet of an alkali metal-zinc-borosilicate glass bonded to a reflecting surface, the glass sheet having a thickness less than 0.5 mm, and being doped with Nd₂O₃ in an amount sufficient to substantially reduce the spectral transmission of the glass in the wavelength range of 565-595 nm, and further doped with CO₃O₄ in the amount of 10-100 ppm, preferably 20-80 ppm, more preferably 30-60 ppm to reduce the pink hue of the glass.

### CROSS-REFERENCE TO RELATED APPLICATION

This application is a continuation-in-part application of U.S. patent application Ser. No. 10/016,840 filed on Dec. 13, 2001 by Ronald R. Stewart, entitled “Thin Sheet Mirror and Nd₂O₃ Doped Glass,” which, in turn, claims the benefit of U.S. Provisional Application Ser. No. 60/255,759, filed on Dec. 15, 2000, entitled “Thin Sheet Mirror and Nd₂O₃ Doped Glass.”

### FIELD OF THE INVENTION

A reflecting mirror comprising a thin sheet of glass, and an alkali metal-zinc-borosilicate glass doped with neodymium oxide (Nd₂O₃) and adapted to be drawn in the form of a thin sheet.

### BACKGROUND OF THE INVENTION

Thin sheet glass, commonly referred to as microsheet, is well known in the glass art. The glass sheets have a thickness less than 0.5 mm, a standard thickness being in the range of 0.3 to 0.4 mm. Microsheet glass is used for such diverse purposes as protective covers for satellite solar cells, laptop LCDs, and glass-plastic laminates.

Mirrors are commonly produced by applying a highly reflecting film or coating of, for example, silver or aluminum, over one flat surface of a glass sheet. Light rays pass through the glass sheet and are reflected back to create the familiar image. Thus, the effective light path in the glass sheet is twice the thickness of the glass sheet.

The present invention is particularly concerned with a rearview mirror such as used in vehicular transport means on sea, on land, or in the air. A problem of long standing is that of visual discomfort, and loss of object definition, created by reflection of certain radiation. The reflection of illumination from a mirror, particularly at night, can be particularly serious. This has led to special mirrors that can be tilted at night. A similar effect occurs with reflected sunlight, especially when the sun is just rising or setting.

It has been reported that this problem largely arises from a relatively narrow portion of the spectral energy distribution in light reflected by a mirror. In terms of color, this is the yellow region which lies primarily between wavelengths of 565 and 595 nm. The red, green and blue regions, which lie outside this wavelength range, appear to provide little or no contribution to the problem.

It is then a primary object of the present invention to provide a reflecting mirror that is improved with respect to the visual discomfort and object blurring that tends to occur with reflected illumination and sunlight.

It is another object to provide a glass that removes, in part at least, the yellow color region in reflected light.

It is a further purpose to provide this selective color effect in glass of microsheet thickness.

It is still another purpose to provide a glass having this desired color absorption effect, in conjunction with viscosity properties that enable the glass to be drawn as microsheet, that is, in a thickness less than 0.5 mm.

### SUMMARY OF THE INVENTION

The invention resides in part in a reflective mirror comprising a sheet of alkali metal-zinc-borosilicate glass bonded to a reflecting surface, the glass having a thickness less than 0.5 mm and being doped with Nd₂O₃ in an amount sufficient to reduce the spectral transmission in the range of 565-595 nm, wherein the alkali metal-zinc-borosilicate glass consists essentially, by weight percent on an oxide basis, of

| | |
|---|---|
| SiO₂ | 55-70% |
| Al₂O₃ | 0.5-4.5% |
| B₂O₃ | 6-14% |
| ZnO | 3-10% |
| Na₂O | 5-11% |
| K₂O | 2-9% |
| Na₂O + K₂O | 7-20% |
| Nd₂O₃ | at least 5%, preferably 5-10% |
| Co₃O₄ | 10-100 ppm. |

The invention further resides in a sheet of an alkali metal-zinc-borosilicate glass containing sufficient Nd₂O₃ in its composition to reduce the transmission of 585 nm wavelength to less than 50% in a 0.6 mm path length, wherein the alkali metal-zinc-borosilicate glass consists essentially, by weight percent on an oxide basis, of

| | |
|---|---|
| SiO₂ | 55-70% |
| Al₂O₃ | 0.5-4.5% |
| B₂O₃ | 6-14% |
| ZnO | 3-10% |
| Na₂O | 5-11% |
| K₂O | 2-9% |
| Na₂O + K₂O | 7-20% |
| Nd₂O₃ | at least 5%, preferably 5-10% |
| Co₃O₄ | 10-100 ppm. |

The present invention has the advantage of improved, more desirable light transmission properties, such that the product has a reduced transmission at about 585 nm and a desired hue under sunlight and incandescent light.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

FIG. 1 in the drawing is a side sectional view of a rear view mirror constructed in accordance with the present invention.

FIG. 2 is a graphical representation illustrating a significant property of Nd₂O₃-doped microsheet in accordance with the invention.

### DETAILED DESCRIPTION OF THE INVENTION

The present invention provides a reflecting mirror, particularly a rearview mirror, in which the visual discomfort and blurring, caused by reflected illumination or sunlight, are alleviated. Such mirrors are widely used in all types of transport vehicles. However, the problem is particularly prevalent in rearview mirrors for automotive vehicles. Accordingly, the invention is described with respect to such application.

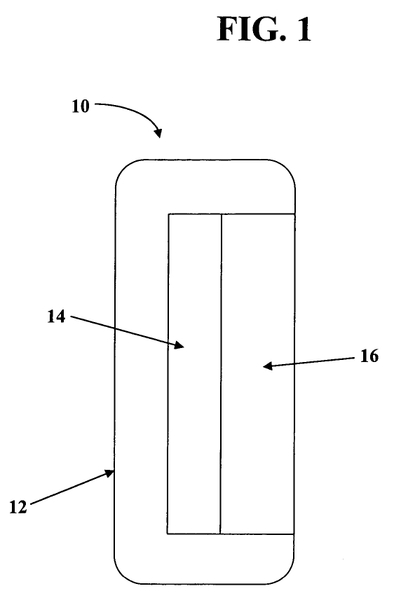

FIG. 1 is a side elevational view of a typical rearview mirror embodying the invention, and generally designated 10. Mirror 10 comprises a standard casing or enclosure 12 and a microsheet glass member 16 having a reflecting surface 14, e.g., a silver film on its rear surface. Glass member 16 may be bonded to casing 12 in known manner. One such structure is shown in U.S. Pat. No. 5,566,031.

The present invention is largely concerned with microsheet glass member 16. As pointed out earlier, microsheet glass is less than 0.5 mm in thickness. For present purposes a thickness of about 0.3 mm is employed. Since reflected light traverses glass twice, the effective light path is about 0.6 mm. Accordingly, transmission data shown hereafter was measured on glass samples having a thickness of 0.6 mm.

It has been found that yellow light, that is spectral radiation having a wavelength within the range of 565-595 nm, is the primary cause of the visual discomfort and blurring. It has further been found that doping a glass with up to 20% Nd₂O₃ will effectively diminish radiation in this yellow region. Surprisingly, and fortunately, the remaining portions of the visible part of the spectrum have little tendency to cause eye discomfort and blurring.

Any amount of Nd₂O₃ doping has some effect, on suppressing the radiation at yellow wavelengths. However, to have a substantial effect, at least about 5% is required. By substantial is meant reduction of the radiation at a wavelength of about 585 nm to a value under 50%. Preferably, as described infra, a preferred Nd₂O₃ amount is 5-10% by weight.

Conventional sheet glass used in mirrors has a thickness in the range of 0.5-4.0 mm, usually about 2 mm. Such sheet glass may be produced by well known rolling or drawing procedures. Accordingly, it is customary to employ a soda lime silicate glass. This may be modified by other divalent metal oxides for special effects.

The production of thinner microsheet glass requires special processing. For present purposes, a special mechanism, known as a slot draw, is employed. One family of glasses successfully slot drawn into microsheet has an alkali metal-zinc-borosilicate base glass. It has been found that Nd₂O₃ does not tend to readily stay dissolved in this base glass. In other words, the glass tends to devitrify with Nd₂O₃ crystals separating in the glass.

This prohibitive tendency can, and must, be avoided by carefully choosing the base glass components and the amounts in which they are present. This will become apparent in a subsequent composition TABLE.

In general, it has been found necessary to use lower B₂O₃ content while employing a higher range content of alkali metal oxides (R₂O) when the Al₂O₃ content is over about 2.5%.

At the same time, microsheet drawing imposes some property limitations that must be observed. In general, these involve glass viscosity versus temperature behavior of a glass melt. In particular, the viscosity at the liquidus temperature must be maintained equal to, and preferably above, 20,000 poises. At the same time, the softening temperature of the glass must be maintained in the range of 700-750° C.

In the TABLE below, several glass compositions are set forth in weight percent on an oxide basis. These compositions, including comparative examples 7 and 8 which devitrified, illustrate the care that must be taken in compounding a suitable glass composition.

| | TABLE | | | | | | | | | | | |
|---|---|---|---|---|---|---|---|---|---|---|---|---|
| | Glass | | | | | | | | | | | |
| | 1 | 2 | 3 | 4 | 5 | 6 | 7 | 8 | 9 | 10 | 11 | 12 |
| Oxide (wt %) | | | | | | | | | | | | |
| SiO₂ | 65.6 | 64.3 | 62 | 60 | 60 | 60 | 60 | 60 | 63 | 57 | 57 | 58 |
| Al₂O₃ | 2.25 | 2.25 | 2.25 | 4.25 | 2.25 | 2.25 | 4.25 | 4.25 | 2.25 | 2 | 2 | 2.25 |
| Na₂O | 7.15 | 7.15 | 7.15 | 7.15 | 5.15 | 5.05 | 4.15 | 6.5 | 6.5 | 7.15 | 6 | 6.5 |
| B₂O₃ | 11.1 | 11.1 | 13.4 | 13.4 | 13.4 | 13.5 | 13.4 | 14 | 14 | 11.1 | 11.1 | 13 |
| K₂O | 6.65 | 3.9 | 3.9 | 3.9 | 3.9 | 3.9 | 2.9 | 0 | 0 | 5.5 | 7.65 | 5 |
| ZnO | 7 | 7 | 7 | 7 | 7 | 5 | 5 | 4 | 4 | 7 | 6 | 7 |
| Sb₂O₃ | 0.25 | 0.25 | 0.25 | 0.25 | 0.25 | 0.25 | 0.25 | 0.25 | 0.25 | 0.25 | 0.25 | 0.25 |
| Nd₂O₃ | 0 | 4 | 4 | 4 | 8 | 8 | 10 | 11 | 10 | 10 | 10 | 8 |
| Property | | | | | | | | | | | | |
| Density (g/cm³) | | | | | | | | | | 2.707 | 2.686 | 2.639 |
| CTE (ppm) | 7.3 | 6.74 | 6.62 | 6.59 | 6.05 | 6.08 | | | 5.27 | 7.69 | 7.81 | 7.43 |
| Tₐₙₙₑₐₗ (° C.) | 554 | 556 | 553 | 545 | 555 | 551 | | | 566 | 557 | 559 | 554 |
| Tₛₜᵣₐᵢₙ (° C.) | 514 | 517 | 515 | 508 | 517 | 511 | | | 528 | 518 | 519 | 515 |
| Tₛₚ (° C.) | 748 | 736 | 730 | 715 | 728 | 740 | | | 751 | 716 | 724 | 714 |
| Liq T (24 hr) (° C.) | | | | | | | | | | 960 | 960 | 960 |
| Liq Visc (kP) | | | | | | | | | | 12 | 17 | 14 |
| Crystal | | | | | | | | | | Nd₂O₃ | Nd₂O₃ | Nd₂O₃ |
| | Glass | | | | | | | | | | | |
| | 13 | 14 | 15 | 16 | 17 | 18 | 19 | 20 | 21 | 22 | 23 | 24 |
| Oxide (wt %) | | | | | | | | | | | | |
| SiO₂ | 58.5 | 60 | 58 | 55 | 55 | 55 | 57 | 57 | 57.8 | 57 | 57 | 58 |
| Al₂O₃ | 2 | 2 | 2.25 | 6 | 6 | 6 | 2 | 2 | 2 | 2.5 | 2.5 | 2.5 |
| Na₂O | 5.4 | 5.4 | 5.2 | 6.2 | 4.45 | 6.75 | 7.15 | 7.15 | 7 | 9.25 | 8.25 | 7.75 |
| B₂O₃ | 12.85 | 11.1 | 13.4 | 11.65 | 13.4 | 12 | 8 | 8 | 7 | 6 | 6 | 6 |
| K₂O | 4 | 4.25 | 4.9 | 4.9 | 5.9 | 4 | 8.6 | 7.6 | 7 | 8 | 8 | 6.5 |
| ZnO | 7 | 7 | 7 | 7 | 7 | 6 | 7 | 8 | 9 | 7 | 8 | 9 |
| Sb₂O₃ | 0.25 | 0.25 | 0.25 | 0.25 | 0.25 | 0.25 | 0.25 | 0.25 | 0.25 | 0.25 | 0.25 | 0.25 |
| Nd₂O₃ | 10 | 10 | 9 | 9 | 8 | 10 | 10 | 10 | 10 | 10 | 10 | 10 |
| Property | | | | | | | | | | | | |
| Density (g/cm³) | | | | | | | | | | | | |
| CTE (ppm) | | | | | | | | | | | | |
| Tₐₙₙₑₐₗ (° C.) | | | | | | | | | | | | |
| Tₛₜᵣₐᵢₙ (° C.) | | | | | | | | | | | | |
| Tₛₚ (° C.) | | | | | | | | | | | | |
| Liq T (24 hr) (° C.) | 1060 | 1060 | 1030 | 1090 | 1085 | 1115 | 930 | 955 | 905 | 955 | 910 | <670 |
| Liq Visc (kP) | | | | | | | 42 | 23 | 55 | 34 | 65 | >1000 |
| Crystal | Nd₂O₃ | Nd₂O₃ | Nd₂O₃ | Nd₂O₃ | Nd₂O₃ | Nd₂O₃ | Nd₂O₃ | Nd₂O₃ | Nd₂O₃ | Nd₂O₃ | Nd₂O₃ | none |

Glass batches were prepared from standard ingredients including sand, alumina, zinc oxide, antimony oxide and Nd₂O₃. Boric acid and/or sodium borate were used as a source of B₂O₃. The alkali metals were added as nitrates or carbonates, or as sodium borate.

The batches were mixed in conventional manner and melted at 1550° C. As noted earlier, glass samples were prepared by grinding and polishing molded blanks to a thickness of 0.6 mm, for making measurements of transmission. Regular blanks were obtained for physical property measurements in accordance with conventional procedures.

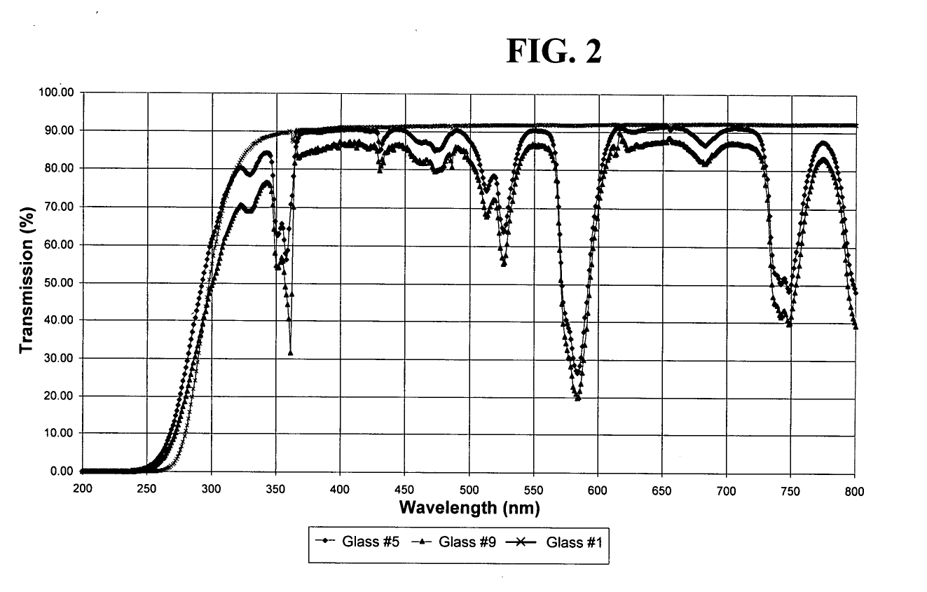

FIG. 2 is a graphical representation comparing the optical transmission curves for 0.6 mm thick glass samples having compositions 1, 5 and 9 in the TABLE above. A 0.6 mm sample is used to correspond to the double passage of radiation in a 0.3 mm thick glass mirror.

The significant feature of the transmission curves, for present purposes, is the steep drop in transmission in the yellow portion of the spectrum, that is, the portion between 565 and 595 nm. Curve A represents composition 1 which contains no Nd₂O₃. This is a typical transmission curve for a non-absorbing, transparent glass containing no colorant or absorbing additive. It shows a steady transmission of slightly over 90% at wavelengths between 380 and 750 nm. In contrast, Curve B is the corresponding transmission curve for the glass sample having composition 5. The transmission of this glass, which contains 8% Nd₂O₃, drops steeply in the yellow region to a low value of about 27% at 585 nm. Likewise, Curve C, based on measurements made on a glass having composition 9, shows a somewhat greater drop to a minimum transmission of about 20% at 585 nm.

Comparison glasses, having compositions 7 and 8, devitrified before a 6 mm thick patty cooled from each melt poured on a steel plate. The crystals formed were precipitated Nd₂O₃. This indicates that the present glasses tend to be unstable as the amount of Nd₂O₃ dopant is increased. Thus, the preferred amount of Nd₂O₃ in the glass is 5-10% by weight. The transmission curves of FIG. 2 indicate the desirability of increased Nd₂O₃ contents however.

To accommodate larger amounts of Nd₂O₃, the base glass must then be adjusted to enhance Nd₂O₃ solubility. At the same time, physical property control must be maintained to permit drawing of glass having microsheet thickness. To this end, the liquidus viscosity must be at least 20,000 poises and preferably higher. Also, the softening point of the glass is desired to be in the range of 670-750° C.

From the liquidus data thus far obtained that are listed in the Table, it appears that the lower Al₂O₃ and B₂O₃ levels tend to permit the Nd₂O₃ to remain in solution. The glass is stiffened by decreasing the B₂O₃ level. This effect can be compensated by concomitant increase of the alkali metal oxides of sodium and potassium along with reducing Al₂O₃. The content of ZnO may also be increased somewhat, and with similar levels of the alkali oxides the glass softening temperature can be further reduced.

In general then, a suitable glass composition will essentially consist, in weight percent on the oxide basis, of:

| | |
|---|---|
| SiO₂ | 55-70% |
| Al₂O₃ | 0.5-4.5% |
| B₂O₃ | 6-14% |
| ZnO | 3-10% |
| Na₂O | 5-11% |
| K₂O | 2-9% |
| Na₂O + K₂O | 7-20% |
| Nd₂O₃ | at least 5%, preferably 5-10%. |

However, it has been found that, as a result of the addition of substantial amount of Nd₂O₃ in the glass, the exemplary glasses exhibit a pinkish hue under incandescent lighting or in sunlight, which is undesirable for some users. In order to remove the pinkish hue, color adjustment of the glass has to be made. To that end, the present inventor has found that the addition of CO₃O₄ into the glass is particularly effective and simple to implement. However, the addition of CO₃O₄ would lead to some transmission loss in the visible range. Therefore, a desirable CO₃O₄ range in the glass is 10-100 ppm by weight of the total glass composition, preferably 20-80 ppm, more preferably 30-60 ppm. It is believed that the higher the Nd₂O₃ content in the glass, the higher amount of CO₃O₄ is required in order to reduce the pinkish hue to substantially the same level.

The present inventor has further melted three glass compositions based on Example 24 above. These three glasses comprise, in addition to the components of the Example 24 glass, 10, 20 and 50 ppm of CO₃O₄, respectively. It was observed under sunlight that the glass with 10 ppm CO₃O₄ has slight reduction of the pinkish hue. At 20 ppm, the reduction of the pinkish hue was clearly visible to the naked eye. At 50 ppm, the pinkish hue was essentially completely removed. Since these examples all have Nd₂O₃ at 10% by weight, it is believed that glasses having lower Nd₂O₃ content, for example, at about 5%, could use a lower CO₃O₄ to effectively reduce or eliminate the pinkish hue to the same extent.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A reflecting mirror comprising a sheet of an alkali metal-zinc-borosilicate glass bonded to a reflecting surface, the glass sheet having a thickness less than 0.5 mm, and being doped with Nd₂O₃ to substantially reduce the spectral transmission of the glass in the wavelength range of 565-595 nm, wherein the alkali metal-zinc-borosilicate glass consists essentially, by weight percent on an oxide basis, of

| | |
|---|---|
| SiO₂ | 55-70% |
| Al₂O₃ | 0.5-4.5% |
| B₂O₃ | 6-14% |
| ZnO | 3-10% |
| Na₂O | 5-11% |
| K₂O | 2-9% |
| Na₂O + K₂O | 7-20% |
| Nd₂O₃ | at least 5% |
| Co₃O₄ | 10-100 ppm. |

2. A reflecting mirror in accordance with claim 1 wherein the glass sheet comprises 5-10% by weight of Nd₂O₃.

3. A reflecting mirror in accordance with claim 1 wherein the glass sheet has a thickness of 0.3 to 0.4 mm.

4. A reflecting mirror in accordance with claim 1 wherein the transmitted radiation at a wavelength of 585 nm is less than 50% when passing a thickness of 0.3 mm twice.

5. A reflecting mirror in accordance with claim 4 wherein the transmitted radiation at 585 nm is less than 30%.

6. A reflecting mirror in accordance with claim 1 wherein the reflecting surface is a silver coating on the back of the glass sheet.

7. A reflecting mirror in accordance with claim 1 wherein the glass comprises 20-80 ppm CO₃O₄.

8. A reflecting mirror in accordance with claim 1 wherein the glass comprises 30-60 ppm CO₃O₄.

9. A thin sheet of alkali metal-zinc-borosilicate glass containing Nd₂O₃ to reduce the transmission of radiation at a wavelength of 585 nm to a value less than 50% at a light path-length of about 6 mm, wherein the alkali metal-zinc-borosilicate glass consists essentially, by weight percent on an oxide basis, of

| | |
|---|---|
| SiO₂ | 55-70% |
| Al₂O₃ | 0.5-4.5% |
| B₂O₃ | 6-14% |
| ZnO | 3-10% |
| Na₂O | 5-11% |
| K₂O | 2-9% |
| Na₂O + K₂O | 7-20% |
| Nd₂O₃ | at least 5% |
| Co₃O₄ | 10-100 ppm. |

10. A glass sheet in accordance with claim 9, wherein the glass comprises 5-10% by weight of Nd₂O₃.

11. A glass sheet in accordance with claim 9 wherein the sheet has a thickness of less than 0.5 mm.

12. A glass sheet in accordance with claim 9 wherein the glass has a liquidus viscosity of at least 20,000 poises and a softening point temperature in the range of 670-750° C.

13. A glass sheet in accordance with claim 9 wherein the glass comprises 20-80 ppm Co₃O₄.

14. A glass sheet in accordance with claim 9 wherein the glass comprises 30-60 ppm CO₃O₄.
